(19) United States
(12) Patent Application Publication
(10) Pub. No.: US 2024/0289148 A1
(43) Pub. Date: Aug. 29, 2024

(54) METHOD OF EXECUTING A JAVA CARD APPLICATION

(71) Applicant: STMicroelectronics International N.V., Geneva (CH)

(72) Inventors: Luigi DI MAGGIO, Mugnano (IT); Ettore MIRTO, Casapulla (IT)

(73) Assignee: STMicroelectronics International N.V., Geneva (CH)

(21) Appl. No.: 18/582,274

(22) Filed: Feb. 20, 2024

(30) Foreign Application Priority Data
Feb. 28, 2023 (EP) 23159037.3

(51) Int. Cl. G06F 9/455; G06F 9/54

(52) U.S. Cl. CPC G06F 9/45529; G06F 9/54

(57) ABSTRACT

A method includes executing an application of a scripting language. The application of the scripting language uses first and second packages of an application programming interface (API). The first and second packages extend to each other. The method includes, from a class of the first package, calling and executing first native code of the API to implement a function of a method of the class of the first package. The first native code is in a programming language different from the scripting language. The executing the first native code of the API includes calling a method of a class of the second package. The called method of the class of the second package is executed using a virtual machine of the scripting language. The application of the scripting language may be a Java card application, and the programming language may be a C programming language.

### BACKGROUND

### Technical Field

Implementations and embodiments of the disclosure relate to integrated circuits that are configured to run scripting language applications, such as Java Card applications.

### Description of the Related Art

Java card is a software technology that allows Java-based applications (applets) to be run securely on an integrated circuit. Java Card technology combines a subset of the Java programming language with a runtime environment optimized for secure elements, such as smart cards and other tamper-resistant security chips, which may be employed, for example, in smart phones, data processing systems, etc. Java card technology offers a secure and interoperable execution platform that can store and update multiple applications on a single resource-constrained device.

The integrated circuit can be an embedded universal integrated circuit card (also known as “eUICC”). An embedded universal integrated circuit card is an evolution of the classical universal integrated circuit card (“UICC”). The embedded universal integrated circuit card is a form of programmable SIM card that is embedded directly into a device.

Such integrated circuits includes a Java Card Runtime Environment to be able to run Java application. The Java Card Runtime Environment comprises a Java Card Virtual Machine and Java Card Application Programming Interfaces (“APIs”).

A Java Card Application programming interfaces has to be programed according to Java card rules. In particular, Java card rules define that it is not possible to import two Java packages that extend to each other. Such cross import of Java packages leads to a Java linker error.

The specification ETSI 102.241, Version 17.1.0 dated August 2021 defines an application programming interface (“API”) and a Runtime Environment for embedded universal integrated circuit cards.

This specification defines a first package called uicc.access.fileadministration and a second package called uicc.access.bertlvfile.

The uicc.access.fileadministration package allows applications to administrate file systems of the embedded universal integrated circuit card. The uicc.access.bertlvfile package provides BER TLV files functions (“BER” being the acronym of Basic Encoding Rules, and “TLV” being the acronym of Type-length-value).

The uicc.access.bertlvfile package defines an AdminBERTLVFile View interface and the uicc.access.fileadministration package defines an AdminFile View interface.

In order to support administrative command on BER TLV files, the uicc.access.bertlvfile package is extended by the AdminFile View interface defined in the uicc.access.fileadministration package.

Besides, the uicc.access.fileadministration package defines a AdminFile ViewBuilder class. This AdminFile ViewBuilder class includes a method called getTheAdminFile View and another method called getTheUICCAdminFileView. These methods return a reference of an object that implements the AdminBERTLVFile View interface, according to the specification ETSI 102.241, Version 17.1.0.

In this case, the AdminBERTLVFile View interface implements the AdminFile View interface and imports uicc.access.fileadministration package as required. On the other side, the AdminFile ViewBuilder class imports the uicc.access.bertlvfile package in order to return a reference of an object implementing the AdminBERTLVFileView interface. Such cross import is not allowed by Java Card. Thus, the compilation of a Java code that require a cross import of packages leads to a Java linker error.

### BRIEF SUMMARY

According to an aspect, an embodiment facilitates allowing two scripting language applications, such as two Java card packages, to extend to each other to allow a third-party scripting language application (e.g., Java card application) to use these packages.

According to one aspect, it is proposed a method of executing on an integrated circuit a Java card application that uses a first package and a second package that extend to each other of a Java card application programming interface, the method comprising, starting from a class of said first package:
calling and executing a native method implementing a function of a Java card method of said class of the first package, then
calling a Java card method of a class of the second package from said native method, then
executing said Java card method of said class of the second package with a Java card virtual Machine.

A native method is a method that is not implemented in the Java programming language, but in another language.

The application programming interface is developed in Java card to facilitate standard access to third party applications, but the methods of the first package is implemented with native methods.

The method allows implementing the first package with native methods and then implementing the second package with the Java card virtual machine.

Implementing the first package with native methods allows overcoming the security restrictions of the Java card virtual machine. Thus, it is possible to implement two Java packages that extend to each other without getting into a Java linking error.

In an embodiment, calling said Java card method of said class of the second package comprises pushing on a Java card stack a class token and a method token of this Java card method.

In an embodiment, the native method is in C programming language.

According to another aspect, it is proposed an integrated circuit, such as an embedded universal integrated circuit card, comprising a processing unit configured to execute a Java card application that uses a first package and a second package that extend to each other of a Java card application programming interface, the processing unit being configured to, starting from a class of said first package:
call and execute a native method implementing a function of a Java card method of said class of the first package,
call a Java card method of a class of a second package from said native method,
execute said Java card method of said class of the second package with a Java card virtual Machine.

In an embodiment, the native method is configured to call the Java card method of said class of the second package by pushing on a Java card stack a class token and a method token of the Java card method.

In an embodiment, the native method is in C programming language.

In an embodiment of a method, an application of a scripting language is executed on an integrated circuit. The application of the scripting language uses first and second packages of an application programming interface (API). The packages extend to each other. The method comprises, from a class of the first package, calling and executing a native method of the API to implement a function of a method of the class of the first package. A method of a class of the second package is called from the native method of the API. The method of the class of the second package is executed using a virtual machine of the scripting language. In an embodiment, the application of the scripting language is a Java card application.

In an embodiment, a device comprises memory and processing circuitry coupled to the memory. The processing circuitry, in operation, executes an application of a scripting language, the application of the scripting language using first and second packages of an application programming interface (API) that extend to each other. The executing the application includes, from a class of the first package, calling and executing a native method of the API to implement a function of a method of the class of the first package, calling, from the native method of the API, a method of a class of the second package, and executing the method of the class of the second package using a virtual machine of the scripting language.

An embodiment of a method includes executing an application of a scripting language. The application of the scripting language uses first and second packages of an application programming interface (API). The first and second packages extend to each other. The method includes, from a class of the first package, calling and executing first native code of the API to implement a function of a method of the class of the first package. The first native code is in a programming language different from the scripting language. The executing the first native code of the API includes calling a method of a class of the second package. The called method of the class of the second package is executed using a virtual machine of the scripting language. The application of the scripting language may be a Java card application, and the programming language may be a C programming language.

In an embodiment, a non-transitory computer-readable medium's contents cause processing circuitry to execute an application of a scripting language. The application of the scripting language using first and second packages of an application programming interface (API) that extend to each other. The executing the application of the scripting language includes, from a class of the first package, calling and executing first code of the API to implement a function of a method of the class of the first package, wherein the first code is in a programming language different from the scripting language. The executing the first code of the API includes calling a method of a class of the second package. The called method of the class of the second package is executed using a virtual machine of the scripting language.

In an embodiment, a system comprises data processing circuitry, and security circuitry coupled to the data processing circuitry. The security circuitry, in operation, executes an application of a scripting language. The application of the scripting language uses first and second packages of an application programming interface (API) that extend to each other. The executing the application includes, from a class of the first package, calling and executing first native code of the API to implement a function of a method of the class of the first package. The first native code is in a programming language different from the scripting language and the executing the first native code of the API includes calling a method of a class of the second package. The called method of the class of the second package is executed using a virtual machine of the scripting language.

### BRIEF DESCRIPTION OF THE SEVERAL VIEWS OF THE DRAWINGS

Other advantages and features of the disclosure will appear in the detailed description of embodiments and implementations, in no way restrictive, and the attached drawings in which:

FIG. 1 is a functional block diagram of an embodiment of an embedded universal integrated circuit card (cUICC).

FIG. 2 schematically illustrates an embodiment of a method of executing a Java card application APPLT that uses two packages of an application programming interface API that extend to each other.

FIG. 3 is a functional block diagram of a system including a universal integrated circuit card.

### DETAILED DESCRIPTION

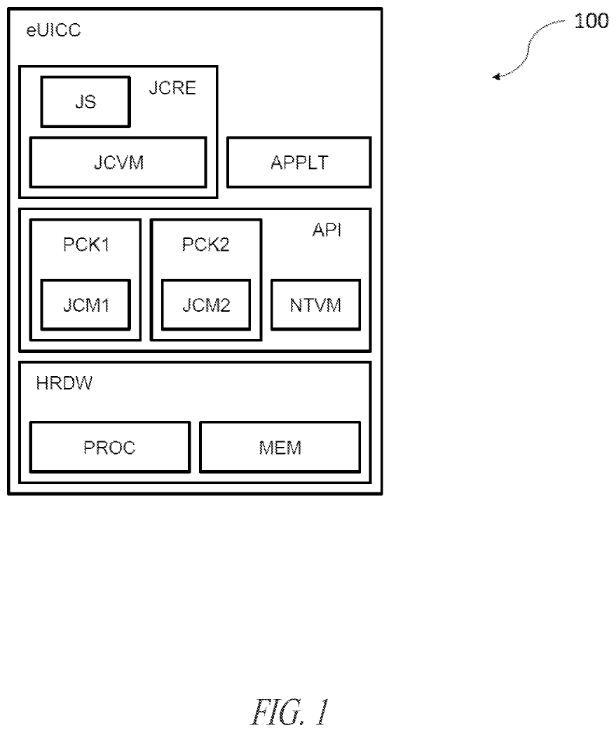

FIG. 1 shows an embedded universal integrated circuit card eUICC 100. The embedded universal integrated circuit card eUICC comprises a hardware HRDW. The hardware HRDW includes a memory MEM and a processing unit or core PROC for example.

The processing unit PROC of the embedded universal integrated circuit card eUICC is configured to run a Java Card Runtime Environment JCRE. The Java Card Runtime Environment JCRE is a software layer that runs on top of a computer's operating system software and provides the class libraries and other resources that a specific Java program needs to run.

The Java Card Runtime Environment JCRE includes a Java stack JS and a Java Card Virtual Machine JCVM. The Java Card Virtual Machine JCVM is an engine that loads Java class files and executes them with a particular set of semantics.

The Java Card Runtime Environment JCRE is configured to load Java packages. A Java package can contain Java classes and interfaces. The package can also contain enumerations, and annotation types. A Java class is a fundamental building block in Java Card. A class describes the data and behavior associated with instances of that class.

The embedded universal integrated circuit card also comprises an application programming interface API. The application programming interface API comprises Java packages and native methods. The application programming interface API comprises a first package PCK1 and a second package PCK2 that extend to each other.

The embedded universal integrated circuit card also comprises a Java card application (“applet”) APPLT of a third-party. This application APPLT uses said first package PCK1 and said second package PCK2 of the application programming interface API.

For example, a first package PCK1 can be a package called uicc.access.fileadministration and the second package PCK2 can be a package called uicc.access.bertlvfile, as defined in the specification ETSI 102.241, Version 17.1.0 dated August 2021. In particular, the uicc.access.fileadministration package allows applications to administrate file systems of the embedded universal integrated circuit card. The uicc.access.bertlvfile package provides BER TLV files functions.

The uicc.access.bertlvfile package defines an AdminBERTLVFile View interface and the uicc.access.fileadministration package defines an AdminFile View interface. In order to support administrative command on BER TLV files, the uicc.access.bertlvfile package is extended by the AdminFile View interface defined in the uicc.access.fileadministration package.

Besides, the uicc.access.fileadministration package defines a AdminFile ViewBuilder class. This AdminFile ViewBuilder class includes a method called getTheAdminFile View and another method called getTheUICCAdminFile View. These methods return a reference of an object that implements the AdminBERTLVFile View interface, according to the specification ETSI 102.241, Version 17.1.0.

In this case, the AdminBERTLVFile View interface implements the AdminFile View interface and imports uicc.access.fileadministration package as required. On the other side, the AdminFile ViewBuilder class imports the uicc.access.bertlvfile package in order to return a reference of an object implementing the AdminBERTLVFile View interface.

To implement these two packages PCK1, PCK2 without getting into a Java Card linker error, the processing unit is configured to implement a Java method JCM1 of the first package PCK1 with a native method NTVM in C code and to implement the second package PCK2 with the Java Card Virtual Machine JCVM.

In particular, the processing unit PROC is configured to call a native method NTVM from a class of the first package PCK1. The native method NTVM is configured to be used to implement a function of a Java card method JCM1 of said class of the first package based on a C code.

For example, a native method NTVM can be defined for the getTheUICCAdminFile View method of the AdminBERTLVFile View interface in the AdminFile ViewBuilder class of the uicc.access.fileadministration package.

Then, the processing unit PROC is configured to call a Java card method JCM2 of the second package from the native context. For example, the Java card method JCM2 can be a CreateBerTlvFile ViewImp method of the class BerTlvFile ViewImp.

In particular, the processing unit PROC is configured to push on a Java stack JS a class token and a method token of the method JCM2 to be called that belong to a class of the second package PCK2. Then, the processing unit PROC is configured to run the Java Card Virtual Machine with the method JCM2 pushed on the Java stack JS. This allows the processing unit PROC to execute the called method JCM2 of the second package PCK2.

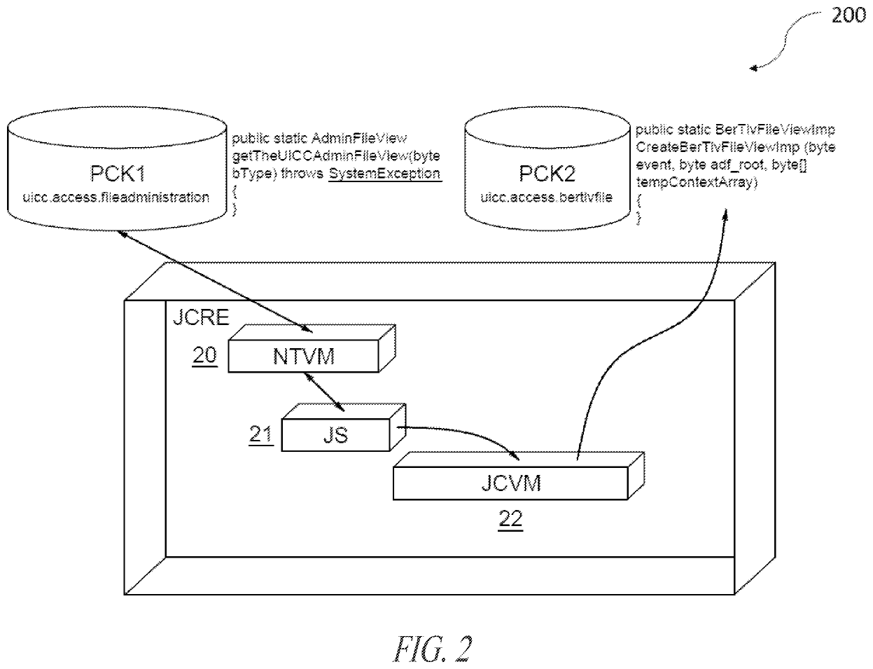

FIG. 2 shows a method 200 of executing a Java card application APPLT that requires to use two packages PCK1, PCK2 of an application programming interface API that extend to each other.

Starting from a class of a first package, the method comprises a step 20 in which a native method is called and executed from this class of the first package PCK1.

Then, the method comprises a step 21 in which a Java card method JCM2 of the second package is called from the native context. In particular, the processing unit PROC is configured to push on a Java stack JS a class token and a method token of the called method JCM2 that belong to a class of the second package PCK2.

Then, the method comprises a step 22 in which the processing unit PROC runs the Java Card Virtual Machine JCVM with a method JCM2 pushed on the Java stack JS.

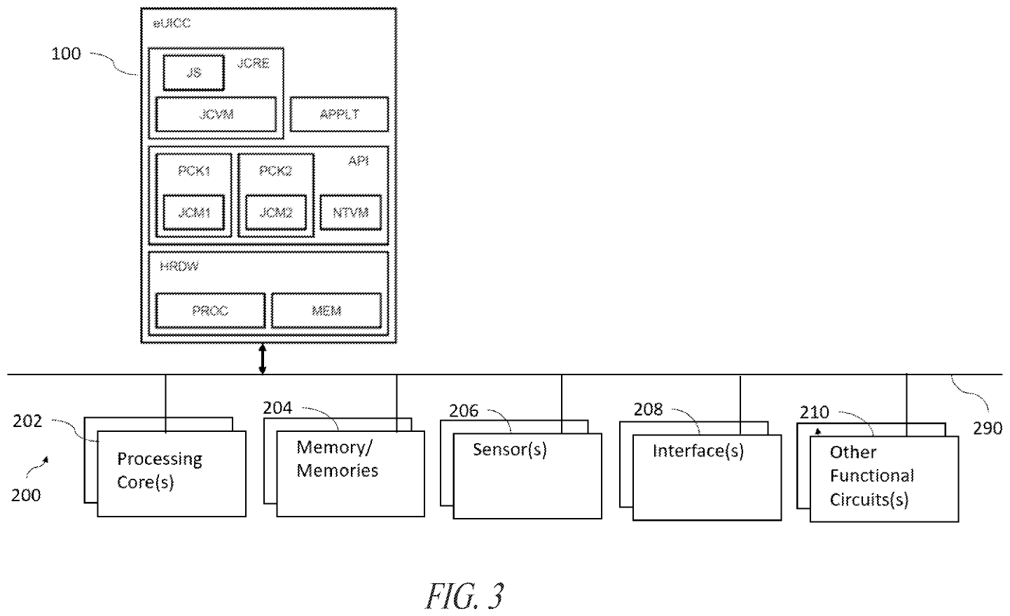

FIG. 3 is a functional block diagram of a system 200 having a universal integrated circuit card. As illustrated, the universal integrated circuit card is an eUICC, such as the eUICC 100 of FIG. 1. The system 200 comprises one or more processing cores or circuits 202. The processing cores 202 may comprise, for example, one or more processors, a state machine, a microprocessor, a programmable logic circuit, discrete circuitry, logic gates, registers, etc., and various combinations thereof. The processing cores may control overall operation of the system 200, execution of application programs by the system 200, such as programs which may request authentication-related services from the cUICC 100, be authenticated by the eUICC 100, etc. In another example, a communication interface 208 may request authentication services from the cUICC 100 to couple the system to a telecommunications network.

The system 200 includes one or more memories 204, such as one or more volatile and/or non-volatile memories which may store, for example, all or part of instructions and data related to control of the system 200, applications and operations performed by the system 200, etc.

The system 200 may include one or more sensors 206 (e.g., image sensors, audio sensors, accelerometers, gyroscopes, pressure sensors, temperature sensors, etc.), one or more interfaces 208 (e.g., wireless communication interfaces, wired communication interfaces, etc.), and other functional circuits 210, which may include antennas, power supplies, one or more built-in self-test (BIST) circuits, etc., and a main bus system 290.

Embodiments of the system 200 of FIG. 3 may include more components than illustrated, may include fewer components than illustrated, may combine components, may separate components into sub-components, and various combination thereof. For example, the eUICC 100 may be embedded into the processing core 202 in some embodiments.

Method of executing on an integrated circuit a Java card application (APLT) that uses a first package (PCK1) and a second package (PCK2) that extend to each other of a Java card application programming interface (API), the method may be summarized as including, starting from a class of said first package (PCK1): calling and executing (20) a native method (NTVM) implementing a function of a Java card method (JCM1) of said class of the first package (PCK1), then calling (21) a Java card method (JCM2) of a class of the second package (PCK2) from said native method (NTVM), then executing (22) said Java card method (JCM2) of said class of the second package with a Java card virtual Machine (JCVM).

Method in which calling said Java card method (JCM2) of said class of the second package (PCK2) may include pushing on a Java card stack (JCS) a class token and a method token of this Java card method (JCM2).

Method in which the native method (NTVM) may be in C programming language.

Integrated circuit may be summarized as including a processing unit (PROC) configured to execute a Java card application (APLT) that uses a first package (PCK1) and a second package (PCK2) that extend to each other of a Java card application programming interface (API), the processing unit (PROC) being configured to, starting from a class of said first package (PCK1): call and execute a native method (NTVM) implementing a function of a Java card method (JCM1) of said class of the first package (PCK1), call a Java card method (JCM2) of a class of a second package (PCK2) from said native method (NTVM), execute said Java card method (JCM2) of said class of said second package with a Java card virtual Machine (JCVM).

Integrated circuit in which the native method (NTVM) may be configured to call the Java card method (JCM2) of said class of the second package (PCK2) by pushing on a Java card stack a class token and a method token of this Java card method (JCM2).

Integrated circuit in which the native method (NTVM) may be in C programming language.

In an embodiment of a method, an application of a scripting language is executed on an integrated circuit. The application of the scripting language uses first and second packages of an application programming interface (API). The packages extend to each other. The method comprises, from a class of the first package, calling and executing a native method of the API to implement a function of a method of the class of the first package. A method of a class of the second package is called from the native method of the API. The method of the class of the second package is executed using a virtual machine of the scripting language. In an embodiment, the application of the scripting language is a Java card application.

In an embodiment, the calling the method of the class of the second package comprises pushing a class token and a method token of the method of the class of the second package on a card stack. In an embodiment, the card stack is a Java card stack and the virtual machine is a Java card virtual machine.

In an embodiment, the native method is in a C programming language.

In an embodiment, the executing the application avoids a linker error associated with rules of the scripting language.

In an embodiment, a device comprises memory and processing circuitry coupled to the memory. The processing circuitry, in operation, executes an application of a scripting language, the application of the scripting language using first and second packages of an application programming interface (API) that extend to each other. The executing the application includes, from a class of the first package, calling and executing a native method of the API to implement a function of a method of the class of the first package, calling, from the native method of the API, a method of a class of the second package, and executing the method of the class of the second package using a virtual machine of the scripting language.

In an embodiment, the application of the scripting language is a Java card application.

In an embodiment, calling the method of the class of the second package comprises pushing a class token and a method token of the method of the class of the second package on a card stack. In an embodiment, the card stack is a Java card stack and the virtual machine is a Java card virtual machine.

In an embodiment, the native method is in a C programming language.

In an embodiment, the executing the application avoids a linker error associated with rules of the scripting language.

In an embodiment, the device comprises an integrated circuit, and the memory and the processing circuitry are embedded in the integrated circuit. In an embodiment, the integrated circuit is an embedded universal integrated circuit card.

In an embodiment of a method, an application of a scripting language is executed. The application of the scripting language uses first and second packages of an application programming interface (API). The first and second packages extend to each other. The method comprises, from a class of the first package, calling and executing first native code of the API to implement a function of a method of the class of the first package. The first native code is in a programming language different from the scripting language. The executing the first native code of the API includes calling a method of a class of the second package. The called method of the class of the second package is executed using a virtual machine of the scripting language.

In an embodiment, the application of the scripting language is a Java card application. In an embodiment, the programming language is a C programming language.

In an embodiment, a non-transitory computer-readable medium's contents cause processing circuitry to execute an application of a scripting language. The application of the scripting language using first and second packages of an application programming interface (API) that extend to each other. The executing the application of the scripting language includes, from a class of the first package, calling and executing first code of the API to implement a function of a method of the class of the first package, wherein the first code is in a programming language different from the scripting language. The executing the first code of the API includes calling a method of a class of the second package. The called method of the class of the second package is executed using a virtual machine of the scripting language.

In an embodiment, the application of the scripting language is a Java card application and the programming language is a C programming language.

In an embodiment, the contents comprise instructions executable by the processing circuitry.

In an embodiment, a system comprises data processing circuitry, and security circuitry coupled to the data processing circuitry. The security circuitry, in operation, executes an application of a scripting language. The application of the scripting language uses first and second packages of an application programming interface (API) that extend to each other. The executing the application includes, from a class of the first package, calling and executing first native code of the API to implement a function of a method of the class of the first package. The first native code is in a programming language different from the scripting language and the executing the first native code of the API includes calling a method of a class of the second package. The called method of the class of the second package is executed using a virtual machine of the scripting language.

In an embodiment, the security circuitry executes the application of the scripting language in response to an authentication request associated with the data processing circuitry.

In an embodiment, the system comprises an embedded universal integrated circuit card including the security circuitry.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of executing an application of a scripting language on an integrated circuit, the application of the scripting language using first and second packages of an application programming interface (API) that extend to each other, the method comprising:
from a class of the first package, calling and executing a native method of the API to implement a function of a method of the class of the first package;
calling, from the native method of the API, a method of a class of the second package; and
executing the method of the class of the second package using a virtual machine of the scripting language.

2. The method according to claim 1, wherein the application of the scripting language is a Java card application.

3. The method according to claim 1, wherein the calling the method of the class of the second package comprises:
pushing a class token and a method token of the method of the class of the second package on a card stack.

4. The method according to claim 3, wherein the card stack is a Java card stack and the virtual machine is a Java card virtual machine.

5. The method according to claim 1, wherein the native method is in a C programming language.

6. The method according to claim 1, wherein the executing the application avoids a linker error associated with rules of the scripting language.

7. A device, comprising:
memory; and
processing circuitry coupled to the memory, wherein the processing circuitry, in operation, executes an application of a scripting language, the application of the scripting language using first and second packages of an application programming interface (API) that extend to each other, the executing the application including:
from a class of the first package, calling and executing a native method of the API to implement a function of a method of the class of the first package;
calling, from the native method of the API, a method of a class of the second package; and
executing the method of the class of the second package using a virtual machine of the scripting language.

8. The device according to claim 7, wherein the application of the scripting language is a Java card application.

9. The device according to claim 7, wherein the calling the method of the class of the second package comprises:
pushing a class token and a method token of the method of the class of the second package on a card stack.

10. The device according to claim 9, wherein the card stack is a Java card stack and the virtual machine is a Java card virtual machine.

11. The device according to claim 7, wherein the native method is in a C programming language.

12. The device according to claim 7, wherein the executing the application avoids a linker error associated with rules of the scripting language.

13. The device of claim 7, comprising an integrated circuit, wherein the memory and the processing circuitry are embedded in the integrated circuit.

14. The device of claim 13, wherein the integrated circuit is an embedded universal integrated circuit card.

15. A method of executing an application of a scripting language, the application of the scripting language using first and second packages of an application programming interface (API) that extend to each other, the method comprising:
from a class of the first package, calling and executing first native code of the API to implement a function of a method of the class of the first package, wherein the first native code is in a programming language different from the scripting language and the executing the first native code of the API includes calling a method of a class of the second package; and
executing the called method of the class of the second package using a virtual machine of the scripting language.

16. The method according to claim 15, wherein the application of the scripting language is a Java card application.

17. The method according to claim 16, wherein the programming language is a C programming language.

18. A non-transitory computer-readable medium having contents which cause processing circuitry to execute an application of a scripting language, the application of the scripting language using first and second packages of an application programming interface (API) that extend to each other, the executing the application of the scripting language including:
from a class of the first package, calling and executing first code of the API to implement a function of a method of the class of the first package, wherein the first code is in a programming language different from the scripting language and the executing the first code of the API including calling a method of a class of the second package; and
executing the called method of the class of the second package using a virtual machine of the scripting language.

19. The non-transitory computer-readable medium of claim 18, wherein the application of the scripting language is a Java card application and the programming language is a C programming language.

20. The non-transitory computer-readable medium of claim 18, wherein the contents comprise instructions executable by the processing circuitry.

21. A system, comprising:
data processing circuitry; and
security circuitry coupled to the data processing circuitry, wherein the security circuitry, in operation, executes an application of a scripting language, the application of the scripting language using first and second packages of an application programming interface (API) that extend to each other, the executing the application including:
from a class of the first package, calling and executing first native code of the API to implement a function of a method of the class of the first package, wherein the first native code is in a programming language different from the scripting language and the executing the first native code of the API includes calling a method of a class of the second package; and
executing the called method of the class of the second package using a virtual machine of the scripting language.

22. The system of claim 21, wherein the security circuitry executes the application of the scripting language in response to an authentication request associated with the data processing circuitry.

23. The system of claim 21, comprising an embedded universal integrated circuit card including the security circuitry.
